(19) United States
(12) Patent Application Publication
(10) Pub. No.: US 2005/0158484 A1
(43) Pub. Date: Jul. 21, 2005

(54) Ink-jet recording sheets

(76) Inventors: Hiroshi Kakihira, Mitsukaido-shi (JP); Kenichi Kawano, Mitsukaido-shi (JP); Akira Kita, Mitsukaido-shi (JP); Hayato Tomihara, Mitsukaido-shi (JP); Koji Fujimoto, Mitsukaido-shi (JP)

Correspondence Address: HARNESS, DICKEY & PIERCE, P.L.C., P.O. BOX 8910, RESTON, VA, 20195, US

(21) Appl. No.: 10/503,892

(22) PCT Filed: Apr. 25, 2003
(86) PCT No.: PCT/JP03/05397

(30) Foreign Application Priority Data
Apr. 25, 2002 (JP) 2002-124597

(51) Int. Cl. B41M 5/40

(52) U.S. Cl. 428/32.34; 428/32.38

(57) ABSTRACT

An ink-jet recording sheet is composed of a base material and at least one ink-receiving layer arranged on at least one side of the base material. The ink-receiving layer comprises a water-soluble resin and/or a water-dispersible resin as a binder, an inorganic pigment, thiourea or a specific derivative thereof, an acrylamide-diallylamine hydrochloride copolymer and/or a polyallylamine acetate, and a boron compound. The inorganic pigment, the thiourea or specific derivative thereof, the acrylamide-diallylamine hydrochloride copolymer and/or polyallylamine acetate and the boron compound satisfy the following equations (1) and (2): 4 (B+C+D)≦A /. . . Equation (1), and (b/D):C=0:15 to 15:0.1 . . . Equation (2)wherein A, B, C, and D represent weight proportions of the inorganic pigment, the thiourea or specific derivative thereof, the acrylamide-diallylamine hydrochloride copolymer and/or polyallylamine acetate and the boron compound, respectively.

### TECHNICAL FIELD

This invention relates to ink-jet recording sheets suitable for performing recording with ink, and especially to ink-jet recording sheets permitting printing of excellent characteristics and inhibited in image fading and discoloration by storage over extended time and also in dye migration after printing when applied to printers or plotters making use of ink-jet recording.

### BACKGROUND ART

Ink-jet recording is a recording technique that performs recording of an image, characters or the like by causing tiny droplets of ink to fly in accordance with one of various operation principles and then allowing them to deposit on a recording medium such as paper. Ink-jet recording features high-speed printing performance, low operating noise, applicability for the recording of a wide variety of characters and patterns, easy multi-color printing, and obviation of development and image fixing. In particular, an image formed by multi-color ink-jet recording can provide a record which is no way inferior to an image printed by multi-color printing making use of a form-plate-dependent printing technique or by a color photographic technique. Ink-jet recording has a still further merit in that, when the number of copies or prints to be made is small, ink-jet recording requires lower printing cost than an ordinary printing technique or photographic technique. Ink-jet recording is, therefore, rapidly finding wide-spread utility as image recorders for various information equipment in recent years. For example, ink-jet recording is finding increasing utility in a wide variety of fields in which recording of full-color images is required, for example, output of image designs in design business, production of color block copies in a printing field where the quality of photographic images is required, and production of billboards and catalogs which are frequently updated.

In such ink-jet recording, improvements have been made in recorders and recording methods to improve recording characteristics, for example, to achieve high-speed recording, high-definition recording and full-color recording. Keeping in step with such improvements, an increasing demand has also arisen for recording media of still higher characteristics. Described specifically, characteristics the demands for which have arisen with respect to recording media to obtain record images at high resolution and high quality comparable with those of silver halide pictures include:
(1) printed dots can have high density and can produce vivid and bright tones,
(2) high contrast can be produced,
(3) ink absorption property is so high that, even when printed dots overlap, ink does not run off or bleed,
(4) spreading or diffusion of ink in horizontal direction does not occur beyond necessity and printed dots have a shape close to a true circle, and
(5) dots are smooth along their peripheries and are well defined.

To meet these requirements, certain proposals have been made to date. For example, JP 52-53012 A discloses ink-jet recording paper of the ordinary plain paper type equipped with ink absorption property increased by applying a surface-processing coating formulation as a thin layer to a base paper stock of low sizing. JP 55-51583 A, JP 59-230787 A and JP 64-11877 A each discloses an ink-jet recording medium of the coated type obtained by applying a coating formulation, which comprises a silicon-containing pigment such as silica and a water-based binder, to a base material to improve the shape and density of dots or tone reproducibility in which the above-described ink-jet recording paper of the ordinary plain paper type had been considered to be poor. Further, to obtain surface gloss comparable with that available from silver halide pictures, it has been attempted to apply cast-coating to an ink-receiving layer or to use a superabsorbent polymer in an ink-receiving layer. These attempts are, however, accompanied by drawbacks in that the former cannot provide sufficient gloss and the latter is slower in ink absorption speed than ink-receiving layers formed of fine particles of an inorganic pigment such as silica.

Proposed as ink-jet recording sheets increased in ink absorption property, gloss and transparency were ink-jet recording sheets each of which had been obtained by applying a fine alumina hydrate together with a water-soluble binder to a base material. For example, JP 60-232990 A discloses recording paper provided with a coating layer which contains porous cationic alumina hydrate. On the other hand, JP-276670 A, JP 6-48016 A, JP 6-55829 A, JP 7-76161 A, JP 8-22608 A, JP 10-44585 A, JP 11-34484 A and JP 2000-239578 A disclose recording sheets containing an alumina hydrate of the pseudo-boehmite structure. In particular, JP 7-76161 A and JP 2000-239578 A disclose recording sheets, each of which contains an alumina sol of the pseudo-boehmite structure and boric acid or a borate salt. In recording media containing such an inorganic pigment, however, recorded images were caused to fade by light, nitrogen oxides, sulfur oxides or ozone in the air, or the like in some instances and under specific conditions, non-printed areas and white backgrounds underwent yellowing.

To avoid these problems, ink-jet recording sheets with various antioxidants, ultraviolet absorbers, light stabilizers and/or the like contained therein have been proposed. For example, JP 57-74192 A, JP 57-87989 A and JP 60-72785 A each discloses ink-jet recording paper which contains a phenolic antioxidant and an ultraviolet absorber of the benzophenone or benzotriazole type.

JP 61-146591 A proposes an ink-jet recording sheet which contains a hindered amine compound, JP 61-154989 A proposes an ink-jet recording sheet which contains a hydrazide compound, JP 1-18684 A proposes an ink-jet recording sheet which contains an undecane compound, JP 1-115677 A proposes an ink-jet recording sheet which contains a thioether compound, JP 6-286297 A discloses an ink-jet recording sheet which contains a linear polycarboxylic acid, and JP 6-316145 A proposes an ink-jet recording sheet which contains an organic acid having an aromatic nucleus.

Further, JP 4-34953 B and JP 7-314883 A each discloses an ink-jet recording sheet containing a thiourea derivative, a thiosemicarbazide derivative, a thiocarbohydrazide derivative or the like. On the other hand, JP 8-25796 A discloses an ink-jet recording sheet which contains one of a thiourea derivative, a thiosemicarbazide derivative and a thiocarbohydrazide derivative and one of iodine, an iodine compound, a dithiocarbamic acid, a thiocyanate salt and a thiocyanate ester. It is, however, the current circumstances that no sufficient effect has been obtained yet from such conventional approaches are not practical, for example, in that dye migration takes place to result in bleeding of an image when exposed to an environment of high temperature and high humidity.

As methods for preventing migration of dyes after printing, many methods have been disclosed including addition of a cationic polymer having tertiary or quaternary ammonium salt groups in an ink-receiving layer and addition of a sizing agent such as an alkylketene dimer or alkenyl succinic anhydride in an ink-receiving layer. However, combined use of the above-mentioned antioxidant, light stabilizer or ultraviolet absorber with a cationic polymer or sizing agent involves many problems in that the migration preventing effect is lost and fading of an image is no longer prevented effectively but on the contrary, may be aggravated. It has, therefore, been difficult to prevent dye migration and image fading and discoloration at the same time.

With the foregoing current circumstances in view, the present invention has as an object the provision of an ink-jet recording sheet which provides high image density, exhibits good tone and ink absorption property, and is inhibited in image fading and discoloration by storage over extended time and also in migration of a dye-containing ink.

### DISCLOSURE OF THE INVENTION

The present inventors have proceeded with various investigations to obtain an ink-jet recording sheet permitting printing of excellent quality and inhibited in image fading and discoloration by storage over extended time and also in dye migration. As a result, it has been found that in an ink-jet recording sheet having an ink-receiving layer composed, as principal components, of an inorganic pigment and a water-soluble resin and/or a water-dispersible resin, incorporation of a compound represented by the below-described formula (1), an acrylamide-diallylamine hydrochloride copolymer and/or a polyallylamine acetate, and a boron compound in the ink-receiving layer makes it possible to achieve the above-described object, leading to the completion of the present invention.

The present invention, therefore, provides an ink-jet recording sheet composed of a base material and at least one ink-receiving layer arranged on at least one side of said base material, characterized in that the ink-receiving layer comprises:
at least one binder resin selected from a water-soluble resin and a water-dispersible resin,
an inorganic pigment,
a compound represented by the following formula (1): 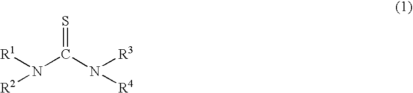
   wherein R¹ to R⁴ may be the same or different and each independently represents a hydrogen atom, an alkyl group, an aryl group or a group represented by —NR⁵R⁶, R⁵ and R⁶ each independently represents a hydrogen atom, an alkyl group having 1 to 5 carbon atoms, a phenyl group or a group represented by —NR⁷CSNR⁸R⁹, R⁷ to R⁹may be the same or different and each independently represents a hydrogen atom, an alkyl group having I to 5 carbon atoms or a phenyl group, and one c. R¹ and R² and one of R³ and R⁴ may be fused together to form a ring,
at least one cationic resin selected from an acrylamide-diallylamine hydrochloride copolymer and a polyallylamine acetate, and
a boron compound; and
the inorganic pigment, the compound, the at least one cationic resin and the boron compound satisfy the following equations (1) and (2):
   4×(B+C+D)≦A Equation (1), and
   (B/D):C=0.1:5 to 15:0.1 Equation (2)
   wherein
A: weight proportion of the inorganic pigment,
B: weight proportion of the compound,
C: weight proportion of the at least one cationic resin, and
D: weight proportion of the boron compound.

In the ink-jet recording sheet according to the present invention, the inorganic pigment may preferably be at least one of alumina, an alumina hydrate of the boehmite structure and an alumina hydrate of the pseudo-boehmite structure; the boron compound may preferably be a boric acid or a borate salt; and the base material may preferably be cast-coated paper, baryta paper, polyolefin-resin-coated paper, or a film.

Owing to the arrangement of the above-described ink-receiving layer, the ink-jet recording sheet according to the present invention permits printing of excellent characteristics, that is, formation of images with excellent density and tone while exhibiting superb ink absorption property and is inhibited in image fading and discoloration by storage over extended time and also in dye migration.

### BEST MODES FOR CARRYING OUT THE INVENTION

The present invention will hereinafter be described more specifically based on certain preferred embodiments.

Preferred examples of the base material for use in the present invention can include base materials composed of paper or the like, such as cast-coated paper, baryta paper, and resin-coated paper both sides of which are coated with a resin such as a polyolefin (hereinafter referred to as “resin-coated paper”), and films. Examples of the films can include transparent films of thermoplastic resins such as polyethylene, polypropylene, polyesters, polylactic acid, polystyrene, polyacetates, polyvinyl chloride, cellulose acetate, polyethylene terephthalate, polymethyl methacrylate and polycarbonates.

Also usable are adequately sized paper, non-sized paper, coated paper, sheet-like materials (synthetic paper and the like) formed of films opacified by inorganic fillers or fine bubbles; and sheets made of glass or metals. To improve the adhesion strength between these base materials and the ink-receiving layers, corona discharge treatment or various undercoating treatments can be applied to surfaces of these base materials.

The inorganic pigment for use in the present invention may preferably be fine inorganic particles, which have high ink-absorbing ability and excellent color producibility and permit formation of images of high quality. Illustrative of such fine inorganic particles are calcium carbonate, magnesium carbonate, kaolin, clay, talc, hydrotalcite, aluminum silicate, calcium silicate, magnesium silicate, diatomaceous earth, alumina, colloidal alumina, aluminum hydroxide, alumina hydrates of the boehmite structure, alumina hydrates of the pseudo-boehmite structure, synthetic amorphous silica, colloidal silica, lithopone, and zeolite. These materials can be used either singly or in combination.

As the form of the above-described fine inorganic particles, their average particle size may be preferably in a range of from 150 nm to 250 nm, more preferably in a range of from 160 nm to 230 nm for obtaining an ink-receiving layer of high gloss and high transparency. Inorganic fine particles the average particle size of which is smaller than 150 nm lead to a substantial reduction in ink absorption property so that, when printed by a printer of high jetting rate, ink bleeding and beading may occur. An average particle size greater than 250 nm, on the other hand, results in an ink-receiving layer lowered in transparency and reduced in print density and gloss. Incidentally, each “average particle size” as referred to herein can be measured by the dynamic light scattering method, and can be determined from an analysis making use of the cumlant method described in “Polymer Structures (2), Scattering Experiments and Form Observations, Chapter 1: Light Scattering” (KYORITSU SHUPPAN CO., LTD.; Compiled by The Society of Polymer Science, Japan) or “J. Chem. Phys., 70(B), 15 Apl., 3965 (1979)”.

The present invention is characterized in that an ink-receiving layer is formed by using the compound represented by the formula (1), the acrylamide-diallylamine hydrochloride copolymer and/or polyallylamine acetate, and the boron compound together with the pigment. In the compound represented by the formula (1), R¹ to R⁹ have the same meanings as defined above. When R¹ to R⁴ are alkyl groups, those having 1 to 10 carbon atoms are preferred. When R¹ to R⁴ are aryl groups, phenyl groups or naphthyl groups are preferred. These alkyl and aryl groups may each be unsubstituted or substituted.

Specific examples of the compound represented by the formula (1) can include those to be described hereinafter. Firstly, illustrative of the compound represented by the formula (1) in which R¹ to R⁴ each represents a hydrogen atom, an alkyl group or an aryl group are:

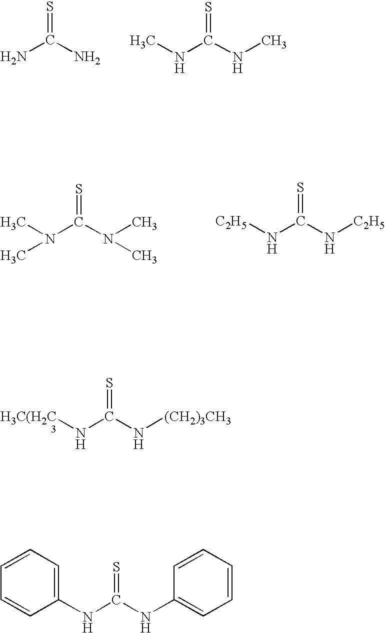

Illustrative of the compound represented by the formula (1) in which at least one of R¹ to R⁴ is a group represented by —NR⁵R⁶ are:

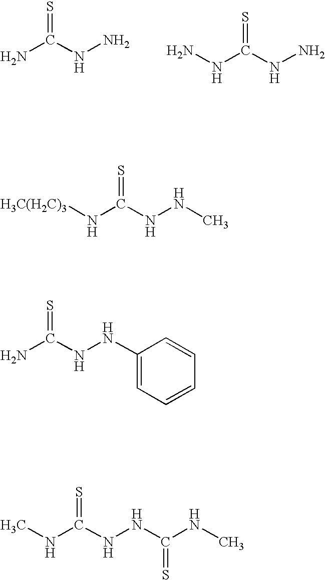

Illustrative of the compound represented by the formula (1) in which one of R¹ and R² and one of R³ and R⁴ may form a ring are:

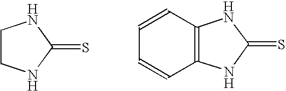

From the viewpoint of ink absorption property and image fading and discoloration preventing effects, the compound represented by the formula (1) may be contained preferably in a proportion of from 0.1 to 20 parts by weight per 100 parts by weight of the inorganic pigment. The more preferred range is from 0.5 to 15 parts by weight per 100 parts by weight of the inorganic pigment. In this more preferred range, ink bleeding or beading hardly occur upon printing.

In the present invention, the boron compound is used along with the compound represented by the formula (1). The boron compound for use in the present invention may preferably be an oxyacid formed around a boron atom as a center or a salt thereof, such as boric acid or a borate salt. Specific examples can include orthophosphoric acid, metaphosphoric acid, hypoboric acid, tetraboric acid and pentaboric acid, and salts thereof.

Boric acid is commonly used as a hardener for improving the film-forming properties, waterproofness and film strength of films formed of hydrophilic polymers. Depending upon the types of reactive groups contained in polymers to be used, various hardeners are chosen, respectively. In the case of a polyvinyl alcohol resin, for example, an epoxy hardener or an inorganic hardener such as boric acid or a water-soluble aluminum salt is used. However, the role of the boron compound in the present invention is to increase the fading preventing effect or the discoloration preventing effect for images when incorporated especially along with the compound represented by the formula (1) in the ink-jet recording sheet, and therefore, is different from that of the same compound in the application where its utility is limited to the effect as a hardener.

To bring about both of the synergistic effect for the prevention of fading and discoloration of images and the good coating work stability, the boron compound may be contained preferably in a proportion of from 0.5 to 5 parts by weight per.100 parts by weight of the inorganic pigment. More preferably, the boron compound may be contained in a proportion of from 1 to 5 parts by weight per 100 parts by weight of the inorganic pigment, and the mixing weight ratio of the boron component to the compound represented by the formula (1) may desirably satisfy the following equation (3):
0.1≦B/D≦15 Equation (3)
wherein B and D have the same meanings as defined above. Insofar as B/D falls within this range, improved fading preventing effect and discoloration preventing effect can be brought about for images.

In the present invention, it is preferred to form an ink-receiving layer by using a cationic resin in combination with the compound represented by the formula (1) and the boron compound. Examples of the cationic resin can include polyallylamine, polyaminesulfone, polyvinylamine, polyethylene-imine, polyamide-epichlorohydrin resin, polyvinylpyridinium halides, polydimethyldiallylammonium chloride, cation-modified products of polyacrylamide, copolymer of acrylamide with cationic monomer copolymers, copolymers of vinyloxazolidone monomers with other general monomers, and copolymers of vinylimidazole monomers and other general monomers Preferred can be acrylamide-diallylamine hydrochloride copolymers and polyallylamine acetates, each of which is excellent in providing a coating formulation with stability and effectively preventing dye migration upon formation of an ink-receiving layer in the present invention. These preferred cationic resins can be used either singly or in combination, and moreover, they can also be used in combination with plural ones of the above-described other cationic resins.

An acrylamide-diallylamine hydrochloride copolymer which can be preferably used in the present invention is a copolymer represented by the below-described formula (2) and formed from acrylamide and diallylamine hydrochloride as constituents. In the formula, the molar fraction (n) of diallylamine is generally in a range of from 0.1 to 0.99, preferably in a range of from 0.15 to 0.95, while the molar fraction (m) of acrylamide is generally in a range of from 0.01 to 0.9, preferably in a range of from 0.05 to 0.85. A diallylamine molar ratio smaller than 0.1 cannot fully bring about waterproofness and the migration preventing effect after ink-jet recording, so that its use in an extremely small molar fraction is not very practical. As the arrangement of monomer units in the polymer chain, any structure is usable so that the acrylamide-diallylamine hydrochloride copolymer can be in a random, alternate, block or multi-block copolymerization form.

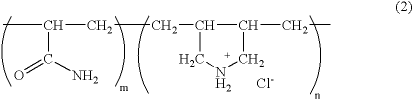

A polyallylamine acetate which can be preferably used in the present invention is a polyallylamine derivative formed of structural units represented by the following formula (3): wherein n stands for a positive number indicating a degree 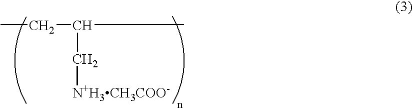
of polymerization.

No particular limitation is imposed on the weight average molecular weight of the cationic resin employed in the present invention, although it may range preferably from 1,000 to 200,000, more preferably from 5,000 to 200,000. A weight average molecular weight lower than 1,000 leads to recorded images of insufficient waterproofness, whereas a weight average molecular weight higher than 200,000 results in a coating formulation the viscosity of which is too high to permit easy handling. Further, a cationic resin of high molecular weight tends to lead to a reduction in the efficiency of bonding with dye molecules due to steric hindrance by its molecular structure so that its waterproofness imparting effect cannot be sufficiently brought about especially when it is added in a small proportion.

The above-described cationic resins, which are suitable for use in the present invention, are generally used as dye fixatives to permit formation of images with improved waterproofness on ink-jet recording sheets. These dye fixatives each forms a salt with a dye having one or more anionic groups and makes the dye insoluble in water, so that images can be formed with improved waterproofness. It is, however, to be noted that, when the acrylamide-diallylamine hydrochloride copolymer and/or the polyallylamine acetate is used in an ink-receiving layer, in which the compound represented by the formula (1) and the boron compound are both contained, as described above, the acrylamide-diallylamine hydrochloride copolymer and/or the polyallylamine acetate can impart waterproofness and the dye migration preventing effect and moreover, can further improve the effect for the prevention of fading and discoloration of images.

The proportion of the acrylamide-diallylamine hydrochloride copolymer and/or the polyallylamine acetate to be used also varies depending on the proportion of the inorganic pigment and the proportion of the water-soluble resin and/or water-dispersible resin to be used as a binder. In general, however, it is preferred to add the acrylamide-diallylamine hydrochloride copolymer and/or the polyallylamine acetate in a proportion of from 0.05 to 5 parts by weight per 100 parts by weight of the inorganic pigment. Further, the mixing weight ratio of the compound represented by the formula (1), the acrylamide-diallylamine hydrochloride copolymer and/or the polyallylamine acetate and the boron compound to be used in the present invention may preferably be set within the range defined by the following equation (2):
(B/D):C=0.1:5 to 15:0.1 Equation (2)
wherein B, C and D have the same meanings as defined above.

When the ratio of C to (B/D) falls within the above range, ink-jet recording sheets further improved in the fading and discoloration preventing effect for images can be obtained with excellent dye migration preventing effect.

In the present invention, it is also preferred to add the compound represented by the formula (1), the acrylamide-diallylamine hydrochloride copolymer and/or the polyallylamine acetate, and the boron compound at such a mixing weight ratio that, within the range satisfying (B/D):C=0.1:5 to 15:0.1 (Equation 2), they satisfy 4×(B+C+D)≦A (Equation 1) wherein A, B, C and D have the same meanings as defined above, that is, the sum of B, C and D is 25 parts by weight or smaller per 100 parts by weight of the inorganic pigment. More preferably, (B+C+D) may fall within a range of from 0.65 to 25 parts by weight per 100 parts by weight of the inorganic pigment. If (B+C+D) exceeds 25 parts by weight, the viscosity of a coating formulation used to form an ink-receiving layer will undergo substantial variations with time, possibly leading to a reduction in the stability of coating work. If (B+C+D) is smaller than 0.65 part by weight, on the other hand, the image fading and discoloration preventing effect and the migration inhibiting effect, both of which are objectives of the present invention, may not be fully brought about in some instances.

The ink-jet recording sheet according to the present invention can be obtained by preparing a coating formulation of the above-described components and then applying the coating formulation to a surface of a base material to form an ink-receiving layer. This ink-receiving layer may preferably include voids, which are formed by the inorganic pigment and a small amount of a water-soluble resin and/or a water-dispersible resin. For the availability of smaller voids, use of alumina, an alumina hydrate of the boehmite structure or an alumina hydrate of the pseudo-boehmite structure as the inorganic pigment is preferred. Particularly preferred is alumina, an alumina hydrate of the boehmite structure or an alumina hydrate of the pseudo-boehmite structure, the BET specific surface area of which is at least 50 m²/g.

An alumina hydrate usable in the present invention can be represented by the following formula (4):
Al₂O₃₋ₙ(OH)₂ₙ.mH₂O (4)
wherein n stands for any one of integers 0, 1, 2 and 3, and m stands for a value of from 0 to 10, preferably from 0 to 5. Because mH₂O represents a removable water phase which may not take part in the formation of a crystal lattice in many instances, m can stands for a value which is not an integer. It is to be noted that m may reach the value of 0 when an alumina hydrate of this sort is subjected to calcination.

In general, an alumina hydrate showing the boehmite structure is a layer compound the (020) crystal plane of which forms a huge plane, and shows a particular diffraction peak in its X-ray diffraction pattern. As the boehmite structure, it is possible to take, in addition to complete boehmite structure, a structure containing excess water between layers of (020) planes and called “pseudo-boehmite”. An X-ray diffraction pattern of this pseudo-boehmite shows a broader diffraction peak than complete boehmite. As complete boehmite and pseudo-boehmite are not clearly distinguishable from each other, they will hereinafter be collectively called an alumina hydrate showing the boehmite structure unless otherwise specifically indicated.

No particular limitation is imposed on the process for the production of an alumina hydrate which has the boehmite structure and is included in an ink-jet recording sheet according to the present invention. It can, therefore, be produced by any known process insofar as it can produce an alumina hydrate having the boehmite structure, for example, by hydrolysis of an aluminum alkoxide or hydrolysis of sodium aluminate.

As disclosed in JP 56-120508 A, an aluminum hydrate which is amorphous as determined by its X-ray diffraction can also be used by subjecting it to heat treatment at 50° C. or higher in the presence of water and converting its structure into the boehmite structure. As a process usable especially preferably, an alumina compound can be obtained by adding an acid to a long-chain aluminum alkoxide and conducting its hydrolysis and deflocculation.

The term “long-chain aluminum alkoxide” as used herein means an alkoxide having 5 or more carbon atoms. Use of an aluminum alkoxide having 12 to 22 carbon atoms is preferred because such a long-chain aluminum alkoxide facilitates elimination of the alcoholic moiety and shape control of the resulting aluminum hydrate as will be described subsequently herein.

As the acid to be added, one or more acids can be chosen at will from organic acids and inorganic acids, and can be used. Nitric acid is most preferred from the standpoint of the efficiency of the hydrolytic reaction and the shape control and dispersibility of the resulting aluminum hydrate. Subsequent to this step, a hydrothermal synthesis can be conducted to control the particle size. When the hydrothermal synthesis is conducted by using an alumina hydrate dispersion which contains nitric acid, the nitric acid in the dispersion is attracted as nitrate groups on surfaces of the alumina hydrate so that the alumina hydrate is improved in water dispersibility.

The above-described process has a merit in that, compared with production processes of alumina hydrogel or cationic alumina, impurities such as various types of ions can be hardly mixed in. Further, a long-chain aluminum alkoxide has another merit in that, because an alcohol can be readily eliminated subsequent to hydrolysis, the dealcoholation of the alumina hydrate can be effected completely compared with use of a short-chain alkoxide such as aluminum isopropoxide.

The ink-jet recording sheet according to the present invention can be obtained by mixing a composition, which comprises the inorganic pigment, the compound represented by the formula (1), the acrylamide-diallylamine hydrochloride copolymer and/or the polyallylamine acetate, and the boron compound, with a water-soluble resin and/or a water-dispersible resin and an aqueous medium in amounts as much as needed into a coating formulation, applying the coating formulation to a surface of a base material and then drying the thus-applied coating formulation into an ink-receiving layer.

As the construction of the ink-jet recording sheet according to the present invention, it is possible to choose a construction with an ink-receiving layer arranged on a base material like coated paper or coated film; a construction with an ink-receiving layer formed by impregnating a base material with a portion or a major portion of a coating formulation in the vicinity of a surface of the base material; or a construction with an ink-receiving layer formed by applying a small amount of a coating formulation to a surface of a base material. In the present invention, these constructions shall all be embraced by the expression that “an ink-receiving layer is formed on a surface of a base material”.

Illustrative of the water-soluble resin and/or water-dispersible resin which is included in the coating formulation are starch, gelatin and casein, and modified products thereof; cellulose derivatives such as methylcellulose, carboxymethylcellulose and hydroxyethylcellulose; completely or partially saponified polyvinyl alcohols and modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes. Preferred is polyvinyl alcohol obtained by hydrolyzing polyvinyl acetate and having an average polymerization degree of from 300 to 5,000. Its saponification degree may preferably be from 70 to lower than 100%, with 80 to 99.5% being particularly preferred. These water-soluble or water-dispersible resins can be used either singly or in combination.

The mixing weight ratio of the inorganic pigment to the water-soluble resin and/or water-dispersible resin in the coating formulation may preferably be in a range of from 1:1 to 30:1, with a range of from 3:1 to 20:1 being more preferred. Setting of the proportion of the water-soluble resin and/or water-dispersible resin within this range makes it possible to provide the resulting ink-receiving layer with resistance to crazing or separation as dust and also with good ink absorption property.

No particular limitation is imposed on the aqueous medium in the coating formulation, insofar as it is water or a mixture of water and a water-miscible organic solvent. Examples of the water-miscible organic solvent can include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

No particular limitation is imposed on the concentration of solids in the coating formulation adapted to form an ink-receiving layer, insofar as the coating formulation has a viscosity sufficient to form the ink-receiving layer on the base material. The preferred solid concentration may, however, range from 5 to 50% by weight based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt. %, on the other hand, results in a coating formulation of high viscosity, and the coatability may be reduced in some instances.

To apply such a coating formulation to a base material, a conventionally-known coating method can be used, such as spin coating, roll coating, blade coating, air knife coating, gate roll coating, bar coating, size pressing, spray coating, gravure coating, curtain coating, rod blade coating, lip coating, or slit die coating. Subsequent to the coating, the surface smoothness of the ink-receiving layer can be improved by using a calender roll or the like as needed.

When a base material having high smoothness, such as resin-coated paper or a film, is used as the base material, the resulting ink-jet recording sheet according to the present invention is provided -with an ink-receiving layer the smoothness of which is high without needing any treatment or processing after application of a coating formulation. When a gloss as high as that of silver halide picture is required, the arithmetic mean roughness (Ra) of the surface of the ink-receiving layer may preferably be 0.1 μm or lower when measured by setting the cut-off value and measurement length at 0.25 mm and 1.25 mm as specified in JIS-B-0601.

As a coat weight of the coating formulation to the base material, the preferred range is from 0.5 to 60 g/m², and the more preferred range is from 5 to 55 g/m². A coat weight smaller than 0.5 g/m² may result in formation of an ink-receiving layer incapable of absorbing water sufficiently from ink so that the ink may run off or an image may bleed. A coat weight greater than 60 g/m², on the other hand, leads to occurrence of curling on an ink-jet recording sheet upon drying so that concerning printing performance, advantageous effects may not be brought about to such marked extent as expected.

As a method for using the compound represented by the formula (1) and the acrylamide-diallylamine hydrochloride copolymer and/or polyallylamine acetate, the compound represented by the formula (1) and the specific cationic resin(s) can be used by adding them directly to a coating formulation as described above or by adding them to an ink-jet recording sheet on which an ink-receiving layer has been formed with the inorganic pigment and other component(s) In the case of the latter method, the compound represented by the formula (1) and the cationic resin(s) can be added to the ink-receiving layer by dissolving or dispersing them in a solvent beforehand and immersing the ink-jet recording sheet in the solution or overcoating the solution to the ink-jet recording sheet.

The ink-jet recording sheet according to the present invention can be obtained by applying the coating formulation to the base material by one of these coating methods and drying the thus-applied coating formulation in a drier such as a hot air drier, hot drum or far-infrared drier. The base material can be provided on one side thereof with an ink-receiving layer or on both sides thereof with ink-receiving layers, respectively. When ink-receiving layers are applied to both sides, respectively, these ink-receiving layers may have the same composition or different compositions.

To the ink-receiving layer of the ink-jet recording sheet according to the present invention, other materials can be added to extents not impairing its performance as an ink-jet recording sheet. Examples of such other materials can include mordant dyes, mordant pigments, dispersants, thickeners, pH adjusters, lubricants, flow modifiers, surfactants, antistatic agents, defoamers, foam inhibitors, penetrants, fluorescent whitening agents, ultraviolet absorbers, and antioxidants.

Although it is not clear why the ink-jet recording sheet of the present invention as described above permits printing of excellent quality and especially exhibits superb effects for the inhibition of fading and discoloration of images by storage over extended time, certain interactions appear to take place among the compound represented by the formula (1), the boron compound and the acrylamide-diallylamine hydrochloride copolymer and/or polyallylamine acetate to develop such effects.

No particular limitation is imposed on ink to be used upon making a record on the ink-jet recording sheet according to the present invention. It is, however, preferred to use general water-base ink for ink-jet recording, in which a dye or pigment is used as a colorant, a mixture of water and a water-miscible organic solvent is used as a medium, and the dye or pigment is dissolved or dispersed in the medium.

As a method for performing the formation of an image by applying the above-described ink onto the ink-jet recording sheet according to the present invention, ink-jet recording is particularly suited. Any ink-jet recording process can be used insofar as it can apply an ink to an ink-jet recording sheet by effectively causing the ink to fly off from a nozzle. A particularly useful process is an ink-jet recording process such as that disclosed in JP 54-59936 A or the like, in which as a result of exposure to action of thermal energy, an ink undergoes a rapid change in volume and the resulting force forces the ink to jet out.

### EXAMPLES

The present invention will hereinafter be described still more specifically based on Examples and Comparative Examples, in which each designation of “part” or “parts” or “%” is on a weight basis unless otherwise specifically indicated.

Rankings and measurements of various physical properties of each ink-jet recording sheet in the present invention were conducted by the following methods.

<Ranking 1: Fading and Discoloration Inhibiting effects>

On each ink-jet recording sheet, solid printing (ink dot area: 100%) was performed with single-color inks of yellow (Y), magenta (M), cyan (C) and black (Bk) by using an ink-jet recording machine (“BJF900”, trade name; manufactured by Canon Inc.). By ozone exposure testing equipment (manufactured by SUGA TEST INSTRUMENTS CO., LTD.; special order equipment), the recorded sheet was exposed to 3 ppm ozone for 2 hours at 40° C. and 55% RH. Changes in color perception at the printed areas were visually ranked. Ink-jet recording sheets were ranked “A” where no difference in color perception was observed with respect to any of the colors, ink-jet recording sheets were ranked “B” where a slight difference in color perception was observed with respect to at least one of the colors, and ink-jet recording sheets were ranked “C” where a significant difference in color perception was observed with respect to at least one of the colors.

<Ranking 2: Migration Preventing Effect>

Using the ink-jet recording machine (“BJF900”, trade name; manufactured by Canon Inc.), solid printing (ink dot area: 100%) was performed with the single-color inks of yellow (Y), magenta (M), cyan (C) and black (Bk) on each ink-jet recording sheet. The recorded sheet was exposed for 1 week to an environment of 30° C. and 80% RH. Degrees of migration of the individual dyes were visually ranked. Ink-jet recording sheets were ranked “A” where no migration took place with respect to any of the colors, ink-jet recording sheets were ranked “B” where slight migration took place with respect to at least one of the colors, and ink-jet recording sheets were ranked “C” where significant migration took place with respect to at least one of the colors.

<Measurement 1: Surface Roughness>

Using “Form Talysurf S5” (trade name, manufactured by Taylor Hobson Ltd.), the arithmetic mean roughness Ra (am) of the surface of the ink-receiving layer on each ink-jet recording sheet was measured by setting the cut-off value and measurement length at 0.25 mm and 1.25 mm as specified in JIS-B-0601.

<Measurement 2: Gloss>

Using a glossmeter (“VG-2000, trade name; manufactured by Nippon Denshoku Industries Co., Ltd.), the 75-deg. Specular gloss, as specified in JIS-Z-8741, of the surface of the ink-receiving layer on each ink-jet recording sheet was measured.

<Preparation of a Dispersion of Alumina Hydrate>

Following the process disclosed in U.S. Pat. No. 4,242,271, aluminum dodexide was prepared. Following the process disclosed in U.S. Pat. No. 4,202,870, the aluminum dodexide was then hydrolyzed to prepare an alumina slurry. Water was added to the alumina slurry until the content of an alumina hydrate having the boehmite structure reached 7.7%. At that time, the pH of the alumina slurry was 9.4. A 3.9% nitric acid solution was added to the slurry to adjust its pH Using an autoclave, the slurry (pre-aging pH: 6. 0) was then subjected to aging (aging temperature: 150° C., aging time: 6 hours) to obtain a colloidal sol. The colloidal sol was spray-dried into an alumina hydrate powder at an inlet temperature of 87° C. The powder so obtained was an alumina hydrate, the particle shape and crystal structure of which were plate-like and the boehmite structure, respectively. Further, the alumina hydrate powder having the boehmite structure was mixed at a concentration of 17% in deionized water to prepare an alumina hydrate dispersion A.

### Example 1

The alumina hydrate dispersion A was agitated at 2,000 rpm for 5 minutes in a homomixer (manufactured by Tokushu Kika Kogyo Co., Ltd.) to obtain a dispersion B. Mixed in the dispersion B (100 parts) were N,N′-diethylthiourea (0.340 part, 2% based on the alumina hydrate), a 3% aqueous solution of boric acid (22.67 parts, 4% based on the alumina hydrate), and “SumirezResin 1001” (0.567 part, 1% based on the alumina hydrate: trade name for an acrylamide-diallylamine hydrochloride copolymer, 30% aqueous solution; product of Sumitomo Chemical Co., Ltd.). To the resulting mixture, a solution (17.0 parts) of polyvinyl alcohol (5 parts; “PVA-224”, trade name; product of Kuraray Co., Ltd.) in deionized water (45 parts) was added to prepare a coating formulation. Using resin-coated paper of 234 g/m² in basis weight (product of Oji Paper Co., Ltd.) as abase material, the above-prepared coating formulation was applied to the base material by die coating to give a dry coat weight of 30 g/m². The thus-coated base material was then placed in an oven (manufactured by Yamato Scientific Co., Ltd.), in which the coated base material was dried at 100° C. for 30 minutes to form an ink-receiving layer. Using the thus-obtained ink-jet recording sheet, the above-described tests for the rankings 1 and 2 and the measurements 1 and 2 were conducted. The results are presented in Table 1.

### Example 2

An ink-jet recording sheet was prepared in a similar manner as in Example 1 except that the amounts of the 3% aqueous solution of boric acid and “SumirezResin 1001” were changed to 11.33 parts (2% based on the alumina hydrate) and 0.283 part (0.5% based on the alumina hydrate), and ranking and measurement tests were conducted. The results are presented in Table 1.

### Example 3

An ink-jet recording sheet was prepared in a similar manner as in Example 1 except that N,N′-dimethylthiourea (0.170 part, 1% based on the alumina hydrate) was used in place of N,N′-diethylthiourea and the amounts of the 3% aqueous solution of boric acid and “SumirezResin 1001” were changed to 5.67 parts (1% based on the alumina hydrate) and 0.057 part (0.1% based on the alumina hydrate), respectively, and ranking and measurement tests were conducted. The results are presented in Table 1.

### Example 4

An ink-jet recording sheet was prepared in a similar manner as in Example 1 except that thiosemicarbazide (2.55 parts, 15% based on the alumina hydrate) was added in place of N,N′-diethylthiourea and the amounts of the 3% aqueous solution of boric acid and “SumirezResin 1001” were changed to 5.67 parts (1% based on the alumina hydrate) and 1.70 parts (3% based on the alumina hydrate), respectively, and ranking and measurement tests were conducted. The results are presented in Table 1.

### Example 5

An ink-jet recording sheet was prepared in a similar manner as in Example 4 except that the amounts of thiosemicarbazide and “SumirezResin 1001” were changed to 1.19 parts (7% based on the alumina hydrate) and 1.13 parts (2% based on the alumina hydrate), respectively, and ranking and measurement tests were conducted. The results are presented in Table 1.

### Example 6

An ink-jet recording sheet was prepared in a similar manner as in Example 4 except that the amount of the 3% aqueous solution of boric acid was changed to 28.33 parts (5% based on the alumina hydrate), and ranking and measurement tests were conducted. The results are presented in Table 1.

### Example 7

An ink-jet recording sheet was prepared in a similar manner as in Example 2 except that “PAA-CH—,CO₂H-L” (trade name for polyallylamine acetate, 25% aqueous solution; product of Nitto Boseki Co., Ltd.) was added in a proportion of 0.340 part (0.5% based on the alumina hydrate) in place of “SumirezResin 1001”, and ranking and measurement tests were conducted. The results are presented in Table 1.

### Example 8

An ink-jet recording sheet was prepared in a similar manner as in Example 2 except that “PAA-CH₃CO₂H-L” was added in a proportion of 0.680 part (1% based on the alumina hydrate) in place of “SumirezResin 1001”, and ranking and measurement tests were conducted. The results are presented in Table 1

### Example 9

An ink-jet recording sheet was prepared in a similar manner as in Example 2 except that the amount of the 3% aqueous solution of boric acid was changed to 5.67 parts (1% based on the alumina hydrate) and “PAA-CH₃CO₂H-L” was added in a proportion of 3.06 parts (4.5% based on the alumina hydrate) in place of “SumirezResin 1001”, and ranking and measurement tests were conducted. The results are presented in Table 1.

### Example 10

An ink-jet recording sheet was prepared in a similar manner as in Example 2 except that “PAA-CH₃CO₂H-L” (0.340 part, 0.5% based on the alumina hydrate) was additionally added, and ranking and measurement tests were conducted. The results are presented in Table 1.

### Comparative Example 1

An ink-jet recording sheet was prepared in a similar manner as in Example 2 except that “SumirezResin 1001” was not added, and ranking and measurement tests were conducted.

The results are presented in Table 1.

### Comparative Example 2

An ink-jet recording sheet was prepared in a similar manner as in Example 2 except that N,N′-diethylthiourea was not added, and ranking and measurement tests were conducted. The results are presented in Table 1.

### Comparative Example 3

An ink-jet recording sheet was prepared in a similar manner as in Example 2 except that neither N,N′-diethylthiourea nor “SumirezResin 1001” was added, and ranking and measurement tests were conducted. The results are presented in Table 1.

### Comparative Example 4

An ink-jet recording sheet was prepared in a similar manner as in Example 2 except that “PAA-HCl-3L” (trade name for polyallylamine acetate, 50% aqueous solution; product of Nitto Boseki Co., Ltd.) was added in a proportion of 0.170 part (0.5% based on the alumina hydrate) in place of “SumirezResin 1001”, and ranking and measurement tests were conducted. The results are presented in Table 1.

### Comparative Example 5

An ink-jet recording sheet was prepared in a similar manner as in Example 2 except that “Sunfix 414” (trade name for polyalkylenepolyamine-dicyandiamide polycondensation product, 50% aqueous solution; product of Sanyo Chemical Industries, Ltd.) was added in a proportion of 0.170 part (0.5% based on the alumina hydrate) in place of “SumirezResin 1001”, and ranking and measurement tests were conducted. The results are presented in Table 1.

### Comparative Example 6

An ink-jet recording sheet was prepared in a similar manner as in Example 2 except that “PAS-M-1” (trade name for diallylmethylamine hydrochloride polymer, 60% aqueous solution; product of Nitto Boseki Co., Ltd,) was added in a proportion of 0.142 part (0.5% based on the alumina hydrate) in place of “SumirezResin 1001”, and ranking and measurement tests were conducted. The results are presented in Table 1.

### Comparative Example 7

An ink-jet recording sheet was prepared in a similar manner as in Example 2 except that boric acid was not added, and ranking and measurement tests were conducted. The results are presented in Table 1.

### Comparative Example 8

An ink-jet recording sheet was prepared in a similar manner as in Example 4 except that the amounts of thiosemicarbazide and the 3% aqueous solution of boric acid were changed to 3.40 parts (20% based on the alumina hydrate) and 17.0 parts (3% based on the alumina hydrate), respectively, and ranking and measurement tests were conducted. The results are presented in Table 1.

TABLE 1

| | Fading and | | Surface | |
|---|---|---|---|---|
| | discoloration | Migration | roughness | 75-deg. |
| | inhibiting effect | preventing effect | Ra (μm) | Gloss |
| Example 1 | A | A | 0.091 | 63.2 |
| Example 2 | A | A | 0.035 | 69.6 |
| Example 3 | A | A | 0.032 | 70.1 |
| Example 4 | A | A | 0.074 | 62.3 |
| Example 5 | A | A | 0.053 | 65.8 |
| Example 6 | A | A | 0.129 | 58.3 |
| Example 7 | A | A | 0.037 | 68.5 |
| Example 8 | A | A | 0.047 | 64.7 |
| Example 9 | A | A | 0.089 | 61.9 |
| Example 10 | A | A | 0.057 | 65.3 |
| Comp. Ex. 1 | B | C | 0.029 | 72.6 |
| Comp. Ex. 2 | C | B | 0.037 | 68.1 |
| Comp. Ex. 3 | C | C | 0.031 | 69.9 |
| Comp. Ex. 4 | C | B | 0.089 | 62.4 |
| Comp. Ex. 5 | B | C | 0.062 | 61.0 |
| Comp. Ex. 6 | B | C | 0.120 | 54.5 |
| Comp. Ex. 7 | B | B | 0.046 | 60.8 |
| Comp. Ex. 8 | A | C | 0.133 | 50.2 |

As is evident from the above Examples and Comparative Examples, the ink-jet recording sheets according to the present invention each of which contained the compound represented by the formula (1), the specific cationic resin and the boron compound in its ink-receiving layer effectively inhibited ozone-related discoloration and fading of images and was excellent in indoor image fastness. At the same time, dye migration under an environment of high temperature and high humidity was also prevented, thereby exhibiting superb storability of images over extended time. Furthermore, the use of the construction of an ink-receiving layer according to the present invention in combination with a base material having high smoothness, such as resin-coated paper or a film, made it possible to obtain a surface of high smoothness without needing any additional treatment or processing after the coating.

Industrial Applicability

Incorporation of a compound represented by the formula (1), an acrylamide-diallylamine hydrochloride copolymer and/or polyallylamine acetate and a boron compound at a specific ratio in an ink-receiving layer can provide an ink-jet recording sheet permitting printing of excellent quality and inhibited in image fading and discoloration by storage over extended time and also in dye migration.

1. An ink-jet recording sheet composed of a base material and at least one ink-receiving layer arranged on at least one side of said base material, characterized in that said ink-receiving layer comprises:
at least one binder resin selected from a water-soluble resin and a water-dispersible resin,
an inorganic pigment,
a compound represented by the following formula (1): 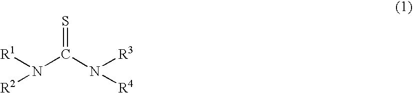
wherein R¹ to R⁴ may be the same or different and each independently represents a hydrogen atom, an alkyl group, an aryl group or a group represented by —NR⁵R⁶, R⁵ and R⁶ each independently represents a hydrogen atom, an alkyl group having 1 to 5 carbon atoms, a phenyl group or a group represented by —NR⁷CSNR⁸R⁹, R⁷ to R⁹ may be the same or different and each independently represents a hydrogen atom, an alkyl group having 1 to 5 carbon atoms or a phenyl group, at least one cationic resin selected from an acylamide-diallylamine hydrochloride copolymer and a polyallylamine acetate, and
a boron compound,
wherein said inorganic pigment is at least one of an alumina hydrate of the boehmite structure and an alumina hydrate of the pseudo-boehmite structure; and
said inorganic pigment, said compound, said at least one cationic resin and said boron compound satisfy the following equations (1) and (2):
4×(B+C+D)≦A Equation (1), and
(B/D):C=0.1:5 to 15:0.1 Equation (2)
wherein
A: weight proportion of said inorganic pigment,
B: weight proportion of said compound,
C: weight proportion of said at least one cationic resin, and
D: weight proportion of said boron compound.

2. (canceled)

3. An ink-jet recording sheet according to claim 1, wherein said boron compound is a boric acid or a borate salt.

4. An ink-jet recording sheet according to claim 1, wherein said base material is cast-coated paper, baryta paper, polyolefin-resin-coated paper, or a film.
